(19) United States
(12) Patent Application Publication
(10) Pub. No.: US 2026/0200590 A1
(43) Pub. Date: Jul. 16, 2026

(54) CONFORMAL HEAT SINK FOR AIR-MOVING DEVICE

(71) Applicant: Whisper Aero Inc., Crossville, TN (US)

(72) Inventors: David Gelwan, West Hartford, CT (US); Andy Yoon, Nashville, TN (US); Colton Johnson, Schenectady, NY (US)

(21) Appl. No.: 19/019,839

(22) Filed: Jan. 14, 2025

(51) Int. Cl. B64D 33/08

(52) U.S. Cl. CPC B64D 33/08

(57) ABSTRACT

An air-moving device may include a control unit configured to control operation of the air-moving device. Heat-generating elements of the control unit may be in thermal contact with a heat sink. The heat sink may include heat-dissipating structures that extend into the path of the airflow generated by the air-moving device. Heat transferred away from the heat-generating elements may be dissipated via the heat-dissipating structures and by the airflow moving past the heat-dissipating structures.

### FIELD

The present disclosures generally relate to heat transfer in air-moving devices, more particularly relate to a heat sink for an air-moving device, and more specifically relate to transferring and dissipating heat from heat-generating elements of a control unit for an air-moving device via heat-dissipation structures positioned in a flow of air generated by the air-moving device.

### BACKGROUND

Air-moving devices are used in a variety of applications. Examples include drying, cooling, moving debris, providing ventilation, providing thrust, hovering, and the like. During operation, a control unit of the air-moving device may generate heat.

### SUMMARY

The following summary presents a general overview of various aspects of the present disclosures. This summary is not an extensive description of all aspects of the present disclosures and should not be understood to identify key or critical elements.

As noted above, aspects of this disclosure generally relate to heat-transfer in air-moving devices. The disclosures herein are presented, by way of example and without limitation, in the context of a propulsor for an aircraft. Examples of aircraft propulsors for which aspects of the present disclosure may be practiced are described in commonly owned U.S. Pat. No. 12,006,891, which is incorporated by reference herein in its entirety. It should be appreciated, however, that the disclosures provided herein may be practiced for a variety of different types of air-moving devices.

Air-moving devices may include electronic control units (controllers) that control the operation of the air-moving devices. Examples of control units for air-moving devices include electronic speed controllers, motor controllers, and the like. Controlling operation of an air-moving device includes, for example, controlling a speed (e.g., rotations per minute, RPM) of the air-moving device. Such control, however, may result in appreciable amounts of heat being generated by the electronic components of a control unit during operation. To ensure the electronic components do not overheat, and potentially damage the control unit or air-moving device, heat management techniques are needed. Example heat management techniques include actively cooling the heat-generating components (e.g., using a cooling fan) and transferring heat away from the heat-generating components where it can be dissipated (e.g., into the ambient environment or another structure or material) using a heat exchanger such as a heat sink.

Aspects of this disclosure are directed to a heat sink that manages the heat generated by the heat-generating components of a control unit for an air-moving device. As described in further detail below, aspects of the present disclosure use the airflow generated by the air-moving device to help dissipate heat transferred away from the heat-generating components of the control unit that controls operation of the air-moving device. In effect, the heat management techniques disclosed herein repurpose the air being moved by the air-moving device to also help maintain the heat-generating elements of the control unit within acceptable temperature levels. As an example, a propulsor for an aircraft may move air to generate thrust. The disclosures herein provide heat-management techniques that use that thrusted airflow to also help dissipate the heat generated by the electronic components of the control unit controlling operation of the propulsor. The thrusted airflow, in this example, thus serves dual purposes of providing both thrust and cooling. In this way, the propulsor itself provides a cooling effect for the control unit that controls it. The heat management techniques disclosed herein thus facilitate maintaining suitable operating conditions for the control unit, the propulsor, and the aircraft. Additional advantages and benefits will be appreciated upon review of the detailed disclosures herein.

As also described in further detail below, the airflow generated by the air-moving device is used to facilitate heat dissipation for a control unit by positioning heat-dissipating structures of the heat sink in the path of the airflow generated by the air-moving device. To continue the example above, a propulsor for an aircraft may include a ducted fan. A control unit assembly that includes the control unit and the heat sink may be mounted to the duct of the propulsor with the heat-dissipating structures of the heat sink extending into the interior of the duct thereby positioning them directly in the flow path of the thrusted air moving through the duct. To facilitate the transfer of heat from the heat-generating elements of the control unit toward the heat-dissipating structures of the heat sink, the heat-generating elements are in direct thermal contact with the heat sink, which is constructed of a thermally conductive material. In this way, heat is transferred via conduction from the heat-generating elements through the heat sink to the heat-dissipating structures that are exposed to the flow path of the thrusted air moving through the duct. Positioning the heat-generating elements to be in direct thermal contact with the heat sink minimizes the mechanical interfaces between the heat-generating elements and the heat-dissipating structures that provide the cooling effect.

As further described herein, the shape of the heat sink may conform to the shape of the air-moving device. For example, a duct of a propulsor may have a rounded (or substantially rounded) shape, and the heat sink may include a similarly rounded shape that conforms to the shape of the duct. Using a heat sink that conforms to the shape of the duct may allow for greater surface area across the heat-dissipating structures. Using a heat sink that conforms to the shape of the duct also may mitigate pressure loss that occurs due to the heat-dissipating structures extending into the interior of the duct. Maintaining a suitable (or desired) fan pressure for a given air-moving application (e.g., producing thrust) may involve maximizing the axial flow of air through the air-moving device. Structures positioned in the flow path of that axial airflow may result in pressure losses. Some pressure loss may be acceptable for a given air-moving application in exchange for heat dissipation that avoids or mitigates overheating. By conforming the shape of the heat sink for the control unit to the shape of the air-moving device, disturbances to the axial flow of air may be minimized or mitigated thus keeping the fan pressure within an acceptable range.

These features and advantages, as well as others, are described in further detail below.

### BRIEF DESCRIPTION OF THE DRAWINGS

The present disclosure is illustrated by way of example and not limited in the accompanying figures in which like reference numerals indicate similar elements and in which:

FIG. 1A depicts a rear perspective view of an example of an air-moving device with an example of a control unit assembly according to various aspects described herein;

FIG. 1B depicts a rear view of the example air-moving device and control unit assembly of FIG. 1A;

FIG. 2A depicts a front perspective view of the example control unit assembly of FIGS. 1A-B;

FIG. 2B depicts a rear perspective view of the example control unit assembly of FIG. 2A;

FIG. 2C depicts a bottom view of the example control unit assembly of FIG. 2A-B;

FIG. 3 depicts a rear view of the example heat sink of FIGS. 2A-C;

FIG. 4A depicts example results of a first temperature model for a first side of an example heat sink according to various aspects described herein;

FIG. 4B depicts example results of a second temperature model for a second side of the example heat sink of FIG. 4A;

FIG. 5 depicts a rear perspective view of an example of a duct for a propulsor according to various aspects described herein;

FIG. 6A depicts a rear perspective view of another example of a control unit assembly according to various aspects described herein;

FIG. 6B depicts a rear view of the example control unit assembly FIG. 6A;

FIG. 6C depicts a rear perspective view of the example assembly of FIGS. 6A-B mounted on an example propulsor according to various aspects described herein;

FIG. 7A depicts a rear perspective view of another example of a control unit assembly mounted on an example propulsor according to various aspects described herein;

FIG. 7B depicts a side cross-sectional view of the example propulsor and control unit assembly of FIG. 7A;

FIGS. 8A-D depict block diagrams of example arrangements of heat-generating elements on a heat sink according to various aspects described herein

FIG. 9A depicts a bottom view of an example configuration of heat-dissipating structures according to various aspects described herein;

FIG. 9B depicts a bottom view of another example configuration of heat-dissipating structures according to various aspects described herein;

FIG. 9C depicts a bottom view of a further example configuration of heat-dissipating structures according to various aspects described herein;

FIG. 10 depicts a partial side perspective view of an example propulsor having a novel heat dissipating device that extends from a center body into the thrust-generating flow path according to various aspects described herein;

FIGS. 11A and 11B depict perspective views of example shrouded heat sinks according to various aspects described herein with FIG. 11A depicting a cross-sectional perspective view of a first example heat sink having a shroud according to aspects described herein and FIG. 11B depicting a perspective view of a second example heat sink having an extended shroud according aspects described herein;

FIGS. 12A, 12B, and 12C depict cross-sectional side views of example recessed heat sink configurations according to aspects described herein with FIG. 12A depicting a first example recessed heat sink configuration in which all or substantially all of the heat-dissipating structures terminate at or about the boundary of the primary flow path, FIG. 12B depicting a second example recessed heat sink configuration in which at least a portion of heat-dissipating structures extend from a recess and into the primary flow path of the thrust-generating air, and FIG. 12C depicting a third example recessed heat sink configuration in which a shroud directs air within the primary flow path into an interior portion of a duct or center body which is returned to the primary air path downstream; and

FIG. 13 depicts a perspective view of an example heat sink having a plurality of pins in accordance with aspects described herein.

### DETAILED DESCRIPTION

In the following description, reference is made to the accompanying drawings, which form a part hereof, and in which is shown by way of illustration various examples in which the disclosure may be practiced. It is to be understood that other examples may be utilized and implemented whereby structural and functional modifications may be made without departing from the scope and spirit of the present disclosure. Further, headings within this disclosure should not be considered as limiting aspects of the disclosure. Those skilled in the art with the benefit of this disclosure will appreciate that the examples are not limited to the headings.

As used herein, a forward direction refers to a direction toward a forward (front) end of an air-moving device and an aftward direction refers to a direction toward an aft (rear) end of an air-moving device. As also used herein, an axial direction refers to a direction along a longitudinal axis of an air-moving device (e.g., generally parallel along the length of an air-moving device). As further used herein, a radial direction refers to a direction along a radius of an air-moving device (e.g., generally perpendicularly from a longitudinal axis toward an outer perimeter) or along another axis that is perpendicular to the longitudinal axis of the air-moving device (e.g., a lateral axis, transverse axis, or vertical axis of an air-moving device). In some example air-moving devices, such as propulsors, air moves from a forward end toward a rear end in an aftward direction. In these example air-moving devices, an inlet may be located at the forward end of the air-moving device and an outlet (e.g., exhaust) may be located at the rear end of the air-moving device. In other example air-moving devices, such as blowers (e.g., handheld blowers), air moves from a rear end toward a forward end in a forward direction. In these example air-moving devices, an inlet may be located at the rear end of the air-moving device and an outlet (e.g., nozzle) may be located at the forward end of the air-moving device. As also used herein, a downstream direction refers to a direction the air is flowing towards, and an upstream direction refers to a direction the air is coming from.

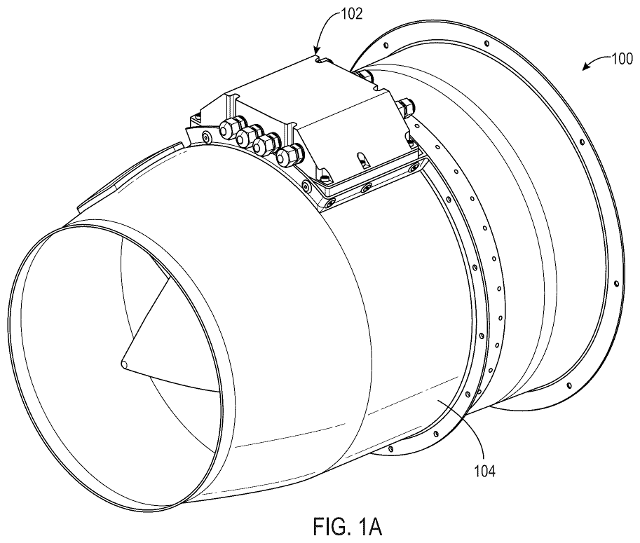

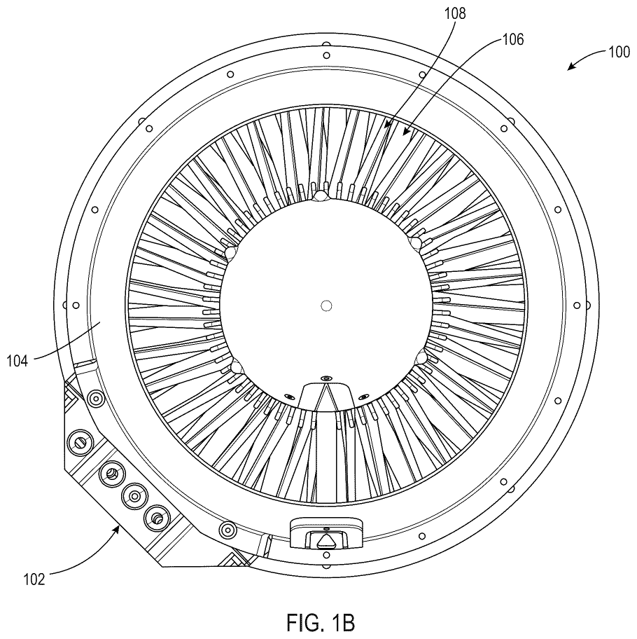

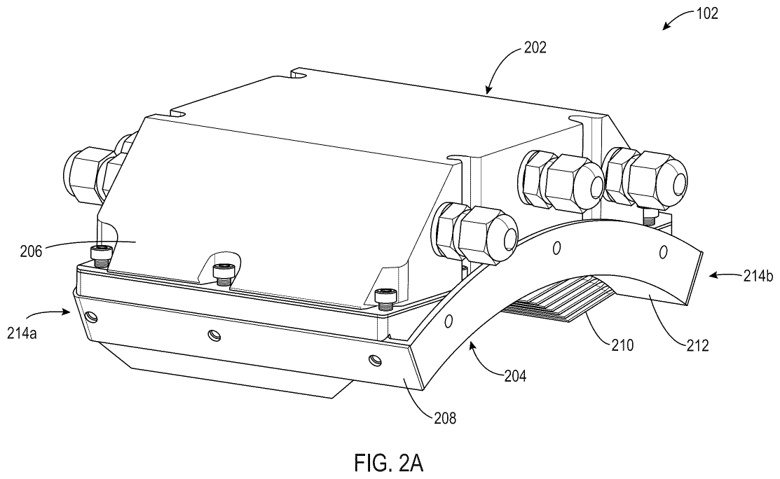

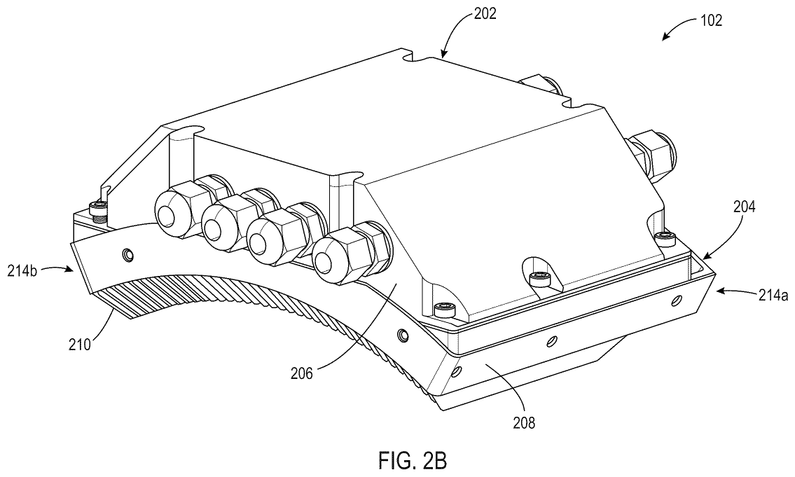

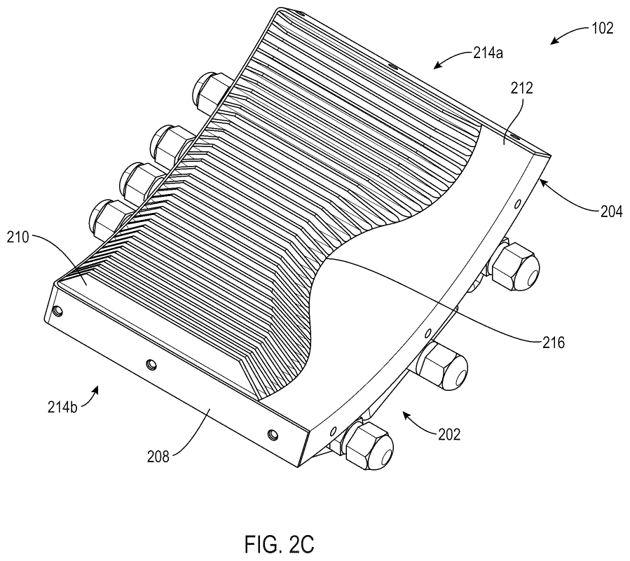

Turning now to FIGS. 1A-B, an example of an air-moving device 100 with an example of a control unit assembly 102. As described in further detail below with reference to FIGS. 2A-C, the control unit assembly 102 includes a control unit and a heat sink. The air-moving device 100, in this example, is a propulsor for an aircraft and includes a duct 104. As seen in FIGS. 1A-B, the control unit assembly 102 is mounted to an exterior side of the duct 104 via radial flanges extending away from the exterior side of the duct. As seen in FIG. 1B, the propulsor 100, in this example, includes an aerodynamic rotor 106 (e.g., a fan) and an aerodynamic stator 108. The stator 108, in this example, is positioned downstream of the rotor 106. The stator 108, in this example, includes multiple stator vanes configured to de-swirl the airflow generated by operating the rotor 106 and facilitate an axial flow of air through the duct 104. The control unit assembly 102, in this example, is positioned downstream of the stator 108. As also described in further detail below, the heat-dissipating structures of the heat sink may axially extend along the heat sink and thus align with the axial flow of air through the duct 104. By positioning the control unit assembly 102 downstream of the stator, the axially extending heat-dissipating structures may align with the de-swirled axial flow of air through the duct thereby facilitating contact between the axially flowing air and the heat-dissipation structures and thus facilitating the dissipation of heat generated by the heat-generating elements of the control unit. The heat-dissipating structures also may be referred to as heat-dissipating elements, thermal-dissipating structures, and thermal-dissipating elements.

FIGS. 2A-C depict respective views of the example control unit assembly 102 of FIGS. 1A-B. The control unit assembly 102, in this example, includes a control unit 202 and a heat sink 204. The control unit 202 may be or otherwise include, for example, an electronic speed controller (ESC). The control unit 202 thus includes various electronic components used to control operation of the air-moving device, which may include, for example, power converters, power resistors, metal-oxide-semiconductor field-effect transistors (MOSFETs), and other electrically conductive components. The electronic components of the control unit 202 may be enclosed in a housing when the control unit is in its assembled configuration and installed at an air-moving device as seen in FIGS. 1A-B and FIGS. 2A-B. The electronic components of the control unit (e.g., the MOSFETs, resistors, and the like) may generate heat during operation. The control unit 202, in this example, includes a substrate 206 that supports the electronic components. The substrate 206, in this example, is a printed circuit board (PCB). The PCB and the components mounted to the PCB may be referred to as a PCB assembly (PCBA). As seen in FIGS. 2A-B, the control unit 202 is supported on and mounted to the heat sink 204. A bracket 208 may be used to mount the control unit 202 to the heat sink 204. In some examples, the substrate 206 of the control unit 202 may be directly mounted to the heat sink 204. In some examples, the substrate (e.g., PCBA) may not be in physical or thermal contact with the heat sink.

As described herein, one or more of the heat-generating components of the control unit 202 may be in direct thermal contact with the heat sink 204 to facilitate heat transfer away from the heat-generating units. In this regard, as described herein, one or more heat-generating elements may be positioned away from the substrate of the control unit (e.g., positioned away from the PCBA of the control unit) and connected to the control unit via leads. Heat-generating elements positioned away from the substrate of the control unit may be mounted to a surface that is not planar with the substrate. In other words, one or more heat-generating elements of the control unit may reside on a different plane than the substrate of the control unit. In some examples, one or more heat-generating elements may be mounted to a surface that is parallel with the substrate of the control unit (e.g., the surface supporting the heat-generating elements may reside in a plane that is parallel to the plane that the substrate resides in). In some examples, one or more heat-generating elements may be mounted to a surface that is oriented at an oblique angle relative to the substrate of the control unit (e.g., the surface supporting the heat-generating elements may reside in a plane that is oblique to the plane that the substrate resides in).

To facilitate dissipation of the heat transferred away from the heat-generating elements of the control unit 202, the heat sink 204 includes heat-dissipating structures 210. The heat-dissipating structures 210 may collectively be referred to as an array of heat-dissipating structures. The heat-dissipating structures 210, in this example, are fins that radially extend away from and axially along a bottom surface 212 of the heat sink 204. As seen in FIGS. 2A-C, the fins 210 are positioned across the bottom surface 212 of the heat sink 204 between respective lateral sides 214a and 214b of the heat sink. As also seen in FIG. 2C, the fins 210, in this example, have different axial lengths with fins near the center of the heat sink 204 having relatively shorter axial lengths and fins near the lateral sides 214a and 214b of the heat sink having relatively longer axial lengths. The respective axial lengths of the fins 210 results in the fins collectively defining a curved fin edge 216. The curved fin edge 216, in this example, has a sinusoidal (e.g., “S” like or “wave” like) shape. For the sake of clarity, not every heat-dissipating structure 210 is labeled in FIGS. 2A-C.

The heat sink 204, in this example, conforms to the shape of the duct 104 of the air-moving device 100. In particular, the bottom surface 212 defines a contour that conforms to the contour of the duct 104. The contour of the bottom surface 212 of the heat sink 204, in this example, is an arcuate contour that conforms to the arcuate contour of the duct 104. In other examples, a heat sink may exhibit alternative shapes and contours that conform to alternative shapes and contours of an air-moving device.

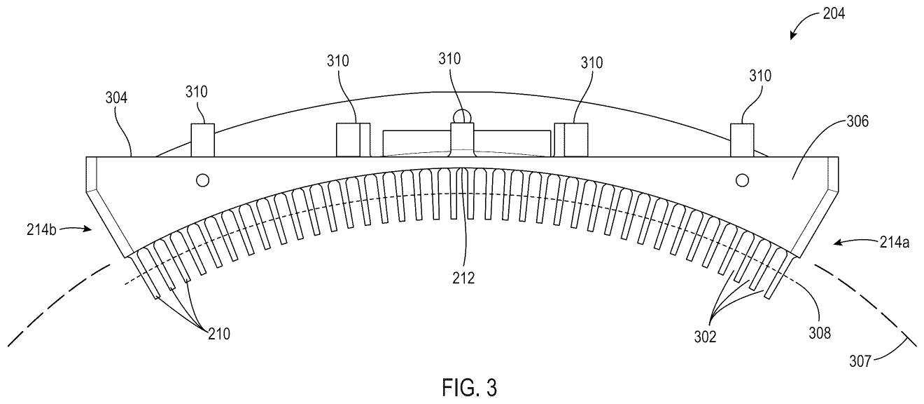

FIG. 3 depicts the example heat sink 204 of the example control unit assembly 102. In FIG. 3, a rear view of the heat sink 204 is shown that depicts the arcuate contour defined by the bottom surface 212 of the heat sink. The contour of the bottom surface 212 of the heat sink 204, in this example, thus conforms to the arcuate contour 307 of a duct of an air-moving device (e.g., a duct of a propulsor). As seen in FIG. 3, each fin 210 is substantially perpendicular to the bottom surface 212 of the heat sink 204. As such, the series of adjacently positioned fins 210 similarly define an arcuate path across the bottom surface 212 of the heat sink 204 between the respective lateral sides 214a and 214b. As also seen in FIG. 3, the fins 210 define respective channels 302 between adjacent fins that axially extend along the axial length of the heat sink 204. The axial channels 302 receive the axially flowing air that moves through the air-moving device. This axial configuration of the fins 210 and channels 302 facilitates the receipt of the axially flowing air into the channels. As the air moves through the channels 302, it comes into contact with the fins 210. Heat from the fins 210 warms the air moving through the channels 302. The warmed air then moves further downstream through the air-moving device thus carrying away the heat dissipated by the fins 210. In some examples, the width of one or more channels between adjacent fins may be between about 2-3 mm (e.g., about 2.15 mm). Additional or alternative widths for one or more channels may be employed. For example, relatively narrower channels may facilitate better heat dissipation at the expense of aerodynamic performance and weight. For example, the width of the channels may be optimized based on the location of the heat-generating elements. As such, some example heat sinks may include channels with different (varying) widths.

The heat sink 204 includes a top surface 304 opposite the bottom surface 212. The top surface 304 of the heat sink 204, in this example, is substantially flat. The top surface 304 thus provides a singular mounting surface for heat-generating elements (e.g., MOSFETs) of the control unit 202 that are in direct thermal contact with the heat sink 204. The heat sink 204 thus transfers heat away from the top surface 304, through a body 306 of the heat sink toward the bottom surface 212 and heat-dissipating structures 210.

As noted above, some pressure loss may occur as a result of the heat-dissipating structures of the heat sink being located in the path of the airflow generated by an air-moving device. Pressure losses may be minimized or mitigated by providing heat-dissipating structures where they are most (or relatively more) useful and omitting heat-dissipating structures where they are least (or relatively less) useful. Heat-dissipating structures may be more useful at the locations of the heat-generating elements of the control unit. The design, configuration, and arrangement of the heat-dissipating structures may depend on and correspond to the locations of the heat-generating elements that are in direct thermal contact with the heat sink as well as the locations of the heat sink where transferred heat is expected. Accordingly, in some examples, the heat-dissipating structures may not axially extend across the entire axial length of a heat sink as shown in FIG. 2C with the variable length fins 210. In other examples, however, heat-dissipating structures may axially extend across the entire axial length of a heat sink. In some examples, the heat-dissipating structures may be laterally positioned across the entirety of a heat sink between its respective lateral sides as also shown in FIG. 2C with the fins 210 positioned between the lateral sides 214a and 214b of the heat sink 204. In other examples, the heat-dissipating structures may be positioned across only a portion of a heat sink, for example from one lateral side of the heat sink toward a middle region of the heat sink or across a middle region of a heat sink toward one or more of the lateral sides. In some examples, the heat-dissipating structures may axially extend across only a portion of the axial length of the heat sink and may be laterally positioned across only a portion of the heat sink.

The configuration of the heat-dissipating structures may be based on anticipated fan pressure losses. The temperature of the heat-generating elements may be directly related to the quantity of heat-dissipating structures (e.g., fins) of a heat sink. Increasing the quantity of heat-dissipating structures may result in lower temperatures but also higher fan pressure losses that reduce the amount of thrust generated by the air-moving device. A higher quantity of heat-dissipating structures thus may provide better cooling of the heat-generating elements but with the tradeoff (expense) of fan pressure loss. The quantity of fins thus may be selected such that, during operation, the heat-generating elements an acceptable temperature (e.g., to avoid overheating) while minimizing fan pressure loss. In some examples, for heat-generating elements (e.g., MOSFETs) of an ESC used to control the speed of a propulsor for an aircraft, an acceptable operating temperature may be around 90° Celsius (C) and an acceptable fan pressure loss may be around 50 Pascals (Pa). More generally, acceptable operating temperatures may depend on the intended useful life of the air-moving device (e.g., between about 90° up to about 120° C.). For example, the operating temperature may be relatively higher (e.g., about 120° C.) for air-moving devices with relatively shorter useful lives, which may have relatively lower cooling requirements. Relatively higher operating temperatures also may decrease fan pressure losses. In addition, effective heat dissipation occurs when a sufficient amount of the airflow through the duct of the air-moving device travels through the channels defined by the heat-dissipating structures rather than traveling around the array of heat-dissipating structures. The amount of airflow that travels through the channels defined by the heat-dissipating structures may be based on the width of the channels (e.g., the lateral distance between the heat-dissipating structures). In addition to quantity, other aspects of the heat-dissipating structures may impact fan pressure loss such as, for example, the length, width, height, and shape of the heat-dissipating structures as well as the distance between heat-dissipating structures. One or more of these aspects may be based on anticipated fan pressure losses as described herein.

The heat-dissipating structures of a heat sink may have different dimensions. The length of a heat-dissipating structure may be the axial length of the heat-dissipating structure measured between a forward end of the heat-dissipating structured and an aft end of the heat-dissipating structure. The width of a heat-dissipating structure may be measured between a lateral side of the heat-dissipating structure and a medial side of the heat-dissipating structure. The height of the heat-dissipating structure may be measured from the base of the heat-dissipating structure to the tip of the heat-dissipating structure opposite the base. The length, width, and height of the heat-dissipating structures may be different in different example heat sinks. For example, heat-dissipating structures of one heat sink may be relatively longer, wider, and/or taller than the heat-dissipating structures of another heat sink. Individual heat-dissipating structures of an example heat sink may have different lengths, widths, or heights. For example, one heat-dissipating structure of an example heat sink may be relatively longer, wider, and/or taller than another heat-dissipating structure of that example heat sink. The length, width, or height of a heat-dissipating structure may vary across the heat-dissipating structure. For example, as shown in FIGS. 2A-C, the length of each heat-dissipating structure 210 tapers at the forward end and aft end such that the heat-dissipating structure is longer at the base and shorter at the tip with the length being longest at the base and shortest at the tip. In other examples, heat-dissipating structures of a heat sink may be shorter at the base and longer at the tip. Additionally or alternatively, the width of a heat-dissipating structure may vary from the base to the tip (e.g., wider at the base and narrower at the tip or narrower at the base and wider at the tip). Additionally or alternatively, the height of a heat-dissipating structure may vary from the forward end to the aft end (e.g., taller at the forward end and shorter at the aft end, shorter at the forward end and taller at the aft end, or shorter at the forward end and aft end and taller between the forward end and the aft end such as a middle region of the heat-dissipating structure). In some examples, the length, width, or height of a heat-dissipating structure may be uniform across the heat-dissipating structure. Heat-dissipating structures that extend along and across only a portion of the heat sink (e.g., axially, between later sides) may also be considered where weight is a factor. For example, if heat-dissipation would be less effective in a certain region of the heat sink (e.g., because no heat-generating element is located in that region or because relatively less heat is transferred to that region), then the heat sink may exclude heat-dissipating structures from that region of the heat sink. FIG. 2C provides an example where the heat sink 204 excludes heat-dissipating structures 210 from certain regions of the bottom surface 212.

The heat-dissipating structures 210 shown by way of example in FIG. 3 have a uniform height across the bottom surface 212 of the heat sink 204. Each heat-dissipating structure 210, in this example, is perpendicular to the bottom surface of the heat sink 204. Due to the arcuate contour of the bottom surface 212, the perpendicularly oriented heat-dissipating structures 210 similarly define an arcuate path 308 between the lateral sides 214a and 214b of the heat sink. As such, a path collectively defined by the heat-dissipating structures may likewise conform to a contour of a duct. A heat sink may include about 20-40 heat-dissipating structures (e.g., fins). In some examples, a heat sink may include a total of 40 axially extending fins each having a height of about 10 mm and a width of about 1 mm. Additional examples of heat sinks with heat-dissipating structures having different quantities, shapes, lengths, widths, heights, orientations, arrangements, and placements will be appreciated with the benefit of this disclosure. For example, one or more of the quantity, height, or width of the heat-dissipating structures may be based on the diameter of the propulsor and vary between propulsors with different diameters. As another example, one or more of the maximum length, the minimum length, the height, and the width of one or more heat-dissipating structures may be based on the intended thrust (e.g., average thrust, maximum thrust), airspeed (e.g., average airspeed, maximum airspeed), and size of the air-moving device (e.g., a propulsor).

The heat sink 204, in this example, also includes support structures 310 connected to and extending away from the top surface 304 of the heat sink. The support structures 310 may support the substrate of a control unit. The support structures 310, in this example, are posts that support the substrate 206 of the control unit 202 (e.g., a PCB) above and away from the top surface 304 of the heat sink. The support structures may be configured to mount the substrate of a control unit to the heat sink and thus may be referred to as mounting posts. In some examples, the posts of the heat sink may exhibit a structural stability that dampens vibrations that occur during operation of the air-moving device. For example, each support structure may include a threaded mounting hole that aligns with a corresponding mounting hole of the substrate that receives a fastener (e.g., screw) that mounts the substrate to the heat sink. Heat-generating elements of a control unit (e.g., MOSFETs) may be in thermal contact with the top-surface 304 of the heat sink 204. The heat-generating elements may be mounted to the top surface 304 of the heat sink 204 in a variety of ways such as thermal pads or thermal paste. For example, thermally conductive clamps (e.g., aluminum clamps) may clamp the heat-generating elements between two thermal pads (e.g., two 1 mm thermal pads). Thermal paste may be relatively lighter than the clamps and thermal pads. As such, thermal paste may be used to mount the heat-generating units to the heat sink in order to minimize a total weight of the control unit assembly. Minimizing the total weight of the control unit assembly may be beneficial, for example, when the control unit is configured for installation in an aircraft where relatively lighter control unit assemblies result in more efficient operation of the aircraft. Other heat-generating elements of the control unit may be mounted to the substrate of the control unit. The support structures of a heat sink (e.g., the support structures 310) also may be thermally conductive. Heat-generated by elements mounted to the substrate of the control unit thus may be transferred away from the substrate via the support structures 310, through the body 306 of the heat sink 204, toward the bottom surface 212 and heat-dissipating structures 210. In its assembled configuration, the heat-generating elements mounted to the top surface 304 of the heat sink 204, in this example, are positioned between (intermediate of) the top surface and the substrate of the control unit.

The heat sink 204 may be constructed of a thermally conductive material configured to conduct heat generated by heat-generating elements in thermal contact with the heat sink. In some examples, a heat sink may be constructed of aluminum. The heat sink may have a monolithic construction such that heat sink is uniformly constructed of the same material (e.g., aluminum) and the heat-dissipating structures are contiguous with the bottom surface of the heat sink. The heat sink may be manufactured using various manufacturing techniques such as casting, stamping, machining, additive deposition, extrusion, and the like. In some examples, the thermal pathway from the heat-generating elements to the heat-dissipating structures may include a minimal number of mating surfaces regardless of how those mating surfaces are attached (e.g., bolted, press-fit, shrink-fit, thermal glue/paste, etc.). Each mating surface may increase thermal resistance and decrease effective heat transfer thus warranting a minimal quantity of mating surfaces to maximize heat transfer.

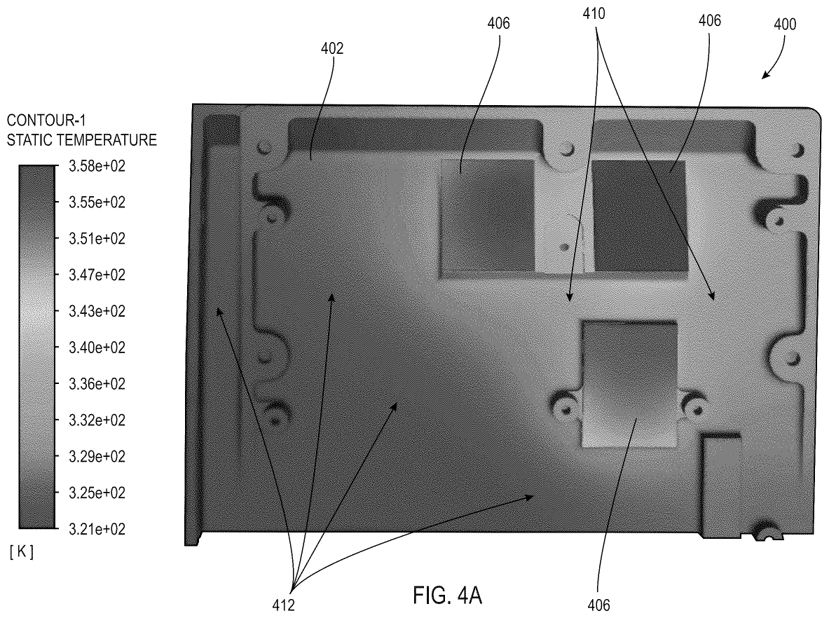

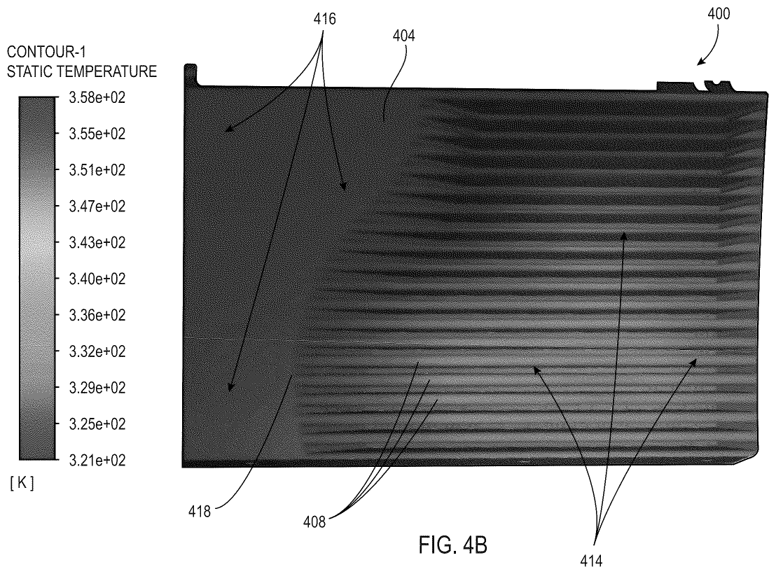

Referring now to FIGS. 4A-B, example results of temperature models for respective sides of an example heat sink 400 are shown. The heat sink 400 may be substantially the same as or similar to the example heat sink 204 discussed above with reference to FIGS. 2A-C and FIG. 3. For ease of reference, FIG. 4A-B depict only about half of the heat sink 400. FIG. 4A depicts a top surface 402 of the heat sink 400, and FIG. 4B depicts a bottom surface 404 of the heat sink. As seen in FIG. 4A, the top surface 402 of the heat sink 400, in this example, includes three mounting areas 406 for heat-generating elements (e.g., MOSFETs) of a control unit. The mounting areas 406, in this example, are arranged in an 2-1 (“L” shaped) arrangement. As seen in FIG. 4B, heat-dissipating structures 408 are attached to and extend away from the bottom surface 404 of the heat sink. The heat-dissipating structures may be substantially the same as or similar to the heat-dissipating structures 210 discussed above with reference to FIGS. 2A-C and FIG. 3. For example, the heat-dissipating structures 408 axially extend along the bottom surface 404 of the heat sink 400 between the lateral sides of the heat sink and have varying lengths. Again for the sake of clarity, not every heat-dissipating structure 408 is labeled in FIG. 4B.

The temperature models of FIGS. 4A-B show that the temperature across the heat sink 400 depends on the placement of the heat-generating elements. For example, as seen in FIG. 4A, the heat-generating elements result in relatively warmer regions 410 closer to the mounting areas 406 and relatively cooler regions 412 farther from the mounting areas with the mounting areas themselves being the hottest regions of the heat sink. As also seen in FIG. 4B, the heat-generating elements similarly result in warmer regions 414 and cooler regions 416 on the bottom surface 404 of the heat sink 400. The warmer regions 414 on the bottom surface 404 of the heat sink 400 correspond to the warmer regions 410 on the top surface 402. Likewise, the cooler regions 416 on the bottom surface 404 of the heat sink 400 correspond to the cooler regions 412 on the top surface 402. The configuration of the heat-dissipating structures 408, therefore, may be based on the regions of the heat sink 400 that are expected to be warmer or cooler as indicated by the temperature model. For the heat sink 400, in this example, the configuration of the heat-dissipating structures 408 is based on the location of the mounting areas 406 and the regions of the heat sink that are anticipated to be warmer or cooler. As such, the heat-dissipating structures 408 collectively define a curved edge 418 (e.g., an “S” shaped edge, a “wave” edge) between the warmer regions 410 and 414 and the cooler regions 412 and 416. As disclosed herein, the arrangement of the heat-generating elements and their corresponding mounting regions on a heat sink may be different in other examples. As such, the configuration of the heat-dissipating structures based on the arrangement of the heat-generating elements in those examples may be different than the configuration shown in FIG. 4B.

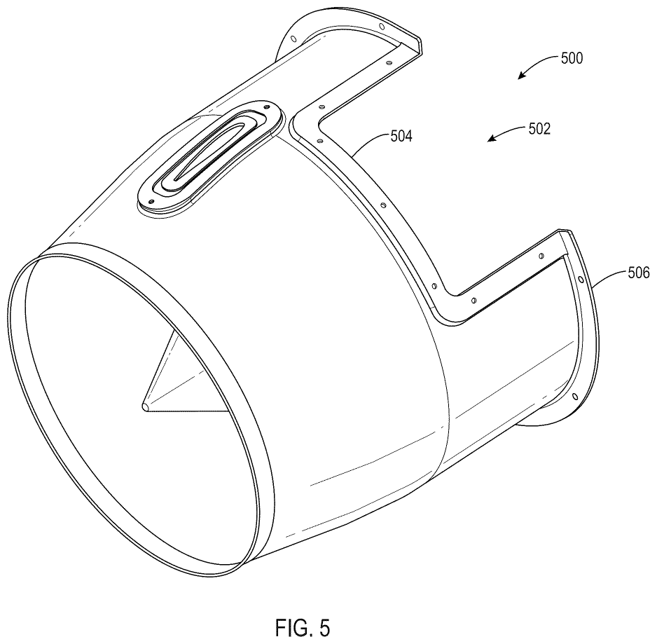

FIG. 5 shows an example duct 500 of a propulsor configured for a control unit assembly as disclosed herein. The duct 500, in this example, includes a mounting region 502. The mounting region 502, in this example, is a cutout (e.g., a “C” shaped cutout) defined by the edge 504 of the duct 500 at a forward end 506 of the duct. The cutout defined by the edge 504 thus allows the heat-dissipating structures of the heat sink to extend into the interior of the duct and be positioned in the flow of air through the duct when the control unit assembly is mounted to the duct. As seen in FIG. 5, the duct 500 includes mounting apertures used to mount the control unit assembly to the duct. Other example ducts may exhibit alternative shapes and locations for the duct, for example, an aperture (e.g., an “O” shaped aperture) located further aft of the forward end of the duct. In some examples, an air-moving device (e.g., a propulsor) may include multiple control units. For example, propulsors may include multiple (e.g., three) ESCs for redundancy and reliability. Such propulsors may include one or more cutouts configured to accommodate the multiple ESCs (e.g., one cutout collectively accommodating all of the ESCs or multiple cutouts individually accommodating one of the ESCs).

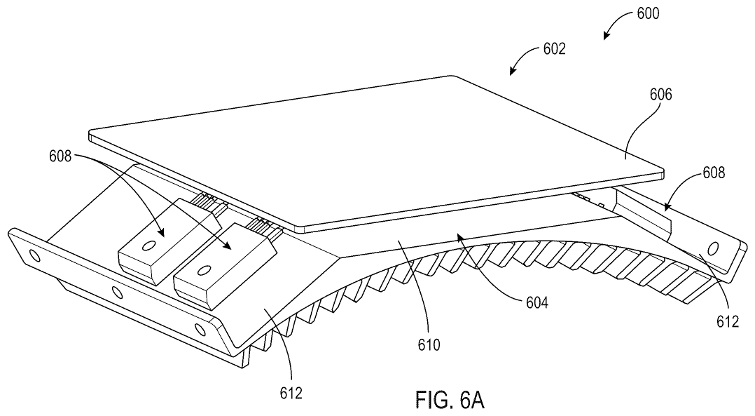

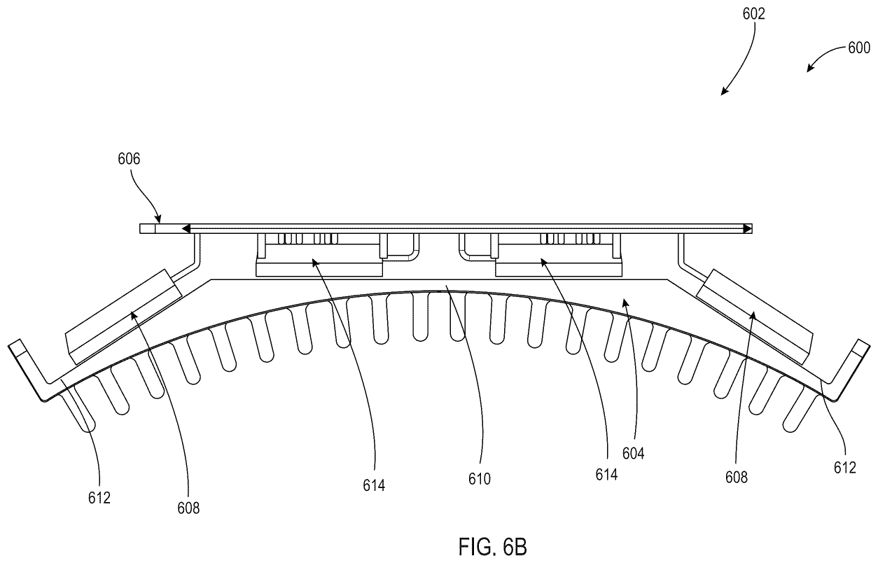

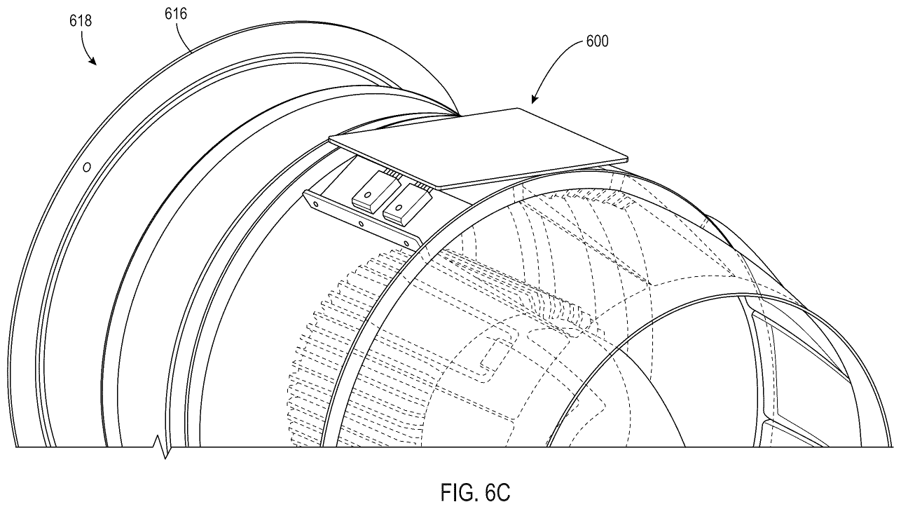

FIGS. 6A-C depict an alternative example of a control unit assembly 600. Similar to the control unit assembly 102 described above with reference to FIGS. 1A-B and FIGS. 2A-C, the example control unit assembly 600 includes a control unit 602 and a heat sink 604. The control unit 602 includes a substrate 606 (e.g., a PCB) and heat-generating elements 608. The heat sink 604, in this example, includes multiple mounting surfaces 610 and 612. In particular, the heat sink 604 includes two mounting surfaces 612 that are oriented at an oblique angle relative to the mounting surface 610. The heat sink 604 includes an obliquely oriented (angled) mounting surface 612 on each side of the mounting surface 610, which is located between the two obliquely oriented mounting surfaces. As seen in FIGS. 6A-C, the mounting surfaces 612 are angled such that they generally follow the curved contour of a duct of an air-moving device (e.g., a duct of a propulsor). The mounting surfaces 610 and 612, in this example, are flat (planar). The substrate 606 of the control unit 602 is mounted to the mounting surface 610, and heat-generating elements 608 (e.g., MOSFETs) are mounted to the angled mounting surfaces 612. As seen in FIG. 6B, the heat-generating elements mounted 608 to the angled mounting surfaces 612, in this example, are positioned away from the substrate 606 of the control unit such that those heat-generating elements are not positioned between (intermediate of) the heat sink 604 and the substrate. As also seen in FIG. 6B, the control unit 602, in this example, also includes heat-generating elements 614 mounted to the mounting surface 610 such that those heat-generating elements are positioned between (intermediate of) the heat sink 604 and the substrate 606. The heat-generating elements 608 and 614, in this example, are connected to the substrate via leads. FIG. 6C shows the control unit assembly 600 installed on an example duct 616 of an example propulsor 618. Although not shown in FIG. 6C, the control unit assembly 600 may also include a housing that mounts to the heat sink and houses the control unit as shown by way of example in FIGS. 1A-B and FIGS. 2A-C.

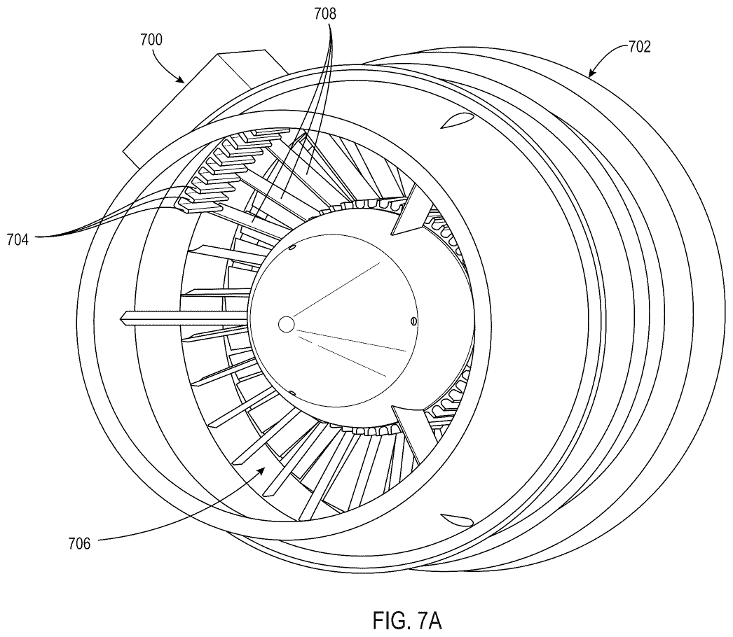

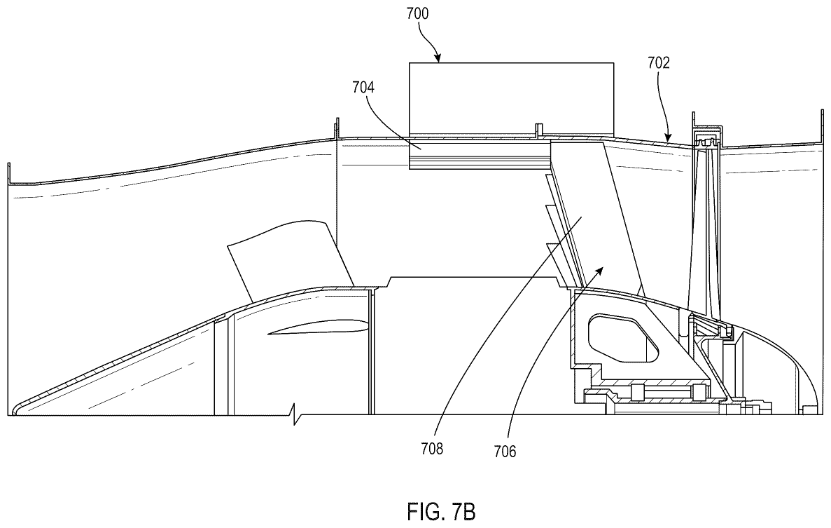

FIGS. 7A-B show another example of a control unit assembly 700 mounted to an example propulsor 702 in a configuration that further facilitates heat transfer and dissipation of the heat generated by the heat-generating elements of the control unit. In the configuration shown in FIGS. 7A-B, heat-dissipating may be enhanced by positioning the heat-dissipating structures 704 of the control unit assembly 700 to be in thermal contact with a stator 706 of the propulsor 702. As seen in FIGS. 7A-B, the heat-dissipating structures 704, in this example, are axially extending fins that are positioned within the interior of the propulsor 702 and are located behind the stator 706. The stator 706 includes radially extending stator vanes 708. As seen in FIG. 7B, at least some of the heat-dissipating structures 704 are in thermal contact with at least some of the stator vanes 708 of the stator. Again for the sake of clarity, not every heat-dissipating structure and stator vane is labeled in FIGS. 7A-B. The stator 706 and the stator vanes 708, in this example, are constructed of a thermally conductive material (e.g., aluminum) that conducts heat away from the heat-dissipating structures 704. In this way, heat-transferred to the heat-dissipating structures 704 from the heat-generating elements of the control unit assembly 700 may be further transferred to the thermally conductive stator vanes 708 of the stator 706 for dissipation. Like the heat-dissipating structures 704, the stator vanes 708 also are positioned with the flow of air generated by the propulsor. The airflow across the stator vanes 708 cools the stator vanes thereby facilitating heat dissipation for the control unit assembly. The air warmed by the heat-dissipating structures 704 and the stator vanes 708 is then expelled from the propulsor thus helping the control unit to stay within acceptable temperature levels.

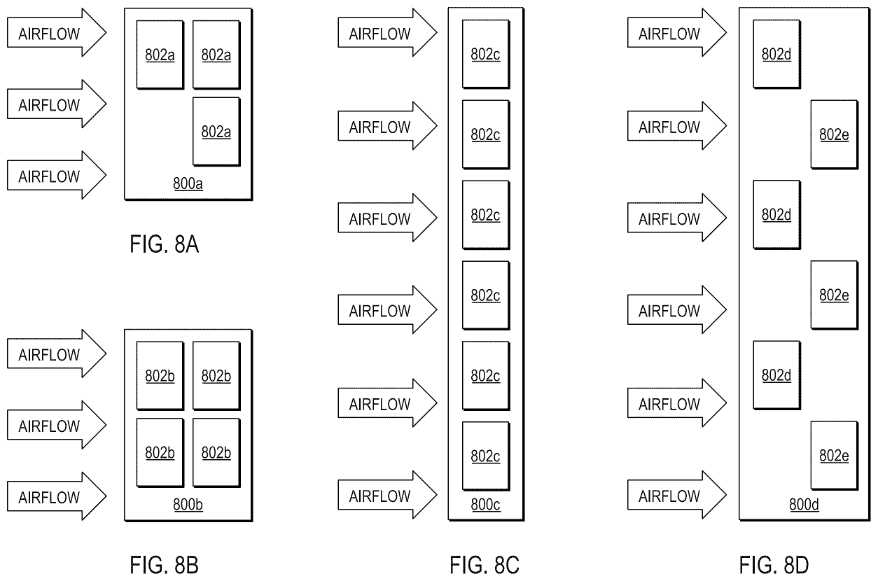

In FIGS. 8A-D, block diagrams of example arrangements of heat-generating elements on a heat sink are shown. Heat transfer and heat dissipation may depend on the arrangement of the heat-generating elements on the heat sink. For example, heat-generating elements that are evenly spread apart on a heat-sink may result in relatively more even heat distribution across the heat sink as compared to heat-generating elements that are clustered close together, which may result in relatively cooler regions and relatively warmer regions of the heat sink during operation. Heat that is more evenly spread out across a heat sink may be dissipated more efficiently or quickly by the heat-generating elements.

To maximize heat distribution across a heat sink, an arrangement of the heat-generating elements in thermal contact with the heat sink may maximize the distance between the heat-generating elements. The maximum distance between the heat-generating elements may depend on various factors such as design constraints, space constraints, tolerances, electrically balancing the heat-generating elements (e.g., MOSFETs) in thermal contact with the heat sink, and the like. In implementations where the control unit is an ESC, for example, providing balanced power (e.g., a balanced three-phase electric power) to a motor of an air-moving device (e.g., a propulsor motor) may be achieved by electrically balancing the heat-generating components (e.g., MOSFETs) of the ESC. Electrically balancing the heat-generating components may include positioning the heat-generating components the same distance away (equidistant) from one or more power sources using leads having substantially the same length. By using leads of the same length to connect the heat-generating components to the power sources, any parasitic resistances or capacitances may be substantially the same for each heat-generating element thus avoiding or mitigating an imbalance in the power provided to the motor of the air-moving device.

Heat dissipation also may depend on the position of the heat-generating elements relative to the flow of air through the air-moving device. As disclosed herein, for example, the air moving through the air-moving device may be warmed by the heat-dissipating structures of the heat sink, which may be referred to as “dirty” air. Air moving through the air-moving device that has not yet been warmed by the heat-dissipating structures may be referred to as “clean” air. A heat-generating element located downstream of another heat-generating element thus may receive the “dirty” air warmed by heat-transferred to the heat-dissipation structures from the upstream heat-generating element. Heat dissipation thus may be relatively less effective for arrangements that position a heat-generating element downstream of another heat generating element as compared to arrangements where no heat-generating element is positioned downstream of another heat-generating element. It will be appreciated, however, that arrangements with heat-generating elements downstream of another heat-generating element may still achieve heat dissipation sufficient to keep the control unit within acceptable temperature levels during operation.

FIG. 8A shows a heat sink 800a with one example arrangement of heat-generating elements 802a. Similar to the arrangement shown in FIG. 4A, the heat-generating elements 802a are arranged, in this example, in an “L” shaped arrangement. The arrangement heat-generating elements 802a in FIG. 4A may also be described as an n×m “L” shaped arrangement with n=2 and m=1 in this example. Other values for n and m are possible and will be appreciated with the benefit of this disclosure. As seen in FIG. 8A, the example arrangement of heat-generating elements 802a includes one heat generating element that is downstream of another heat generating element. As such, heat-dissipating structures located near the upstream heat-generating element receive the “clean” airflow through the air-moving device while the heat-dissipating structures located near the downstream heat-generating element receive the “dirty” airflow warmed by the heat-dissipating structures located near the upstream heat-generating element.

FIG. 8B shows a heat sink 800b with another example arrangement of heat-generating elements 802b. The heat-generating elements 802b are arranged, in this example, in an n×m rectangular (e.g., square) arrangement with n=2 and m=2. Other values for n and m again are possible and will be appreciated with the benefit of this disclosure. As seen in FIG. 8B, the example arrangement of heat-generating elements 802b includes two upstream heat-generating elements and two downstream heat-generating elements.

FIG. 8C shows a heat sink 800c with another example arrangement of heat-generating elements 802c. The heat-generating elements 802c are arranged, in this example, in an n×1 linear arrangement with n=6. Other values for n again are possible and will be appreciated with the benefit of this disclosure. As seen in FIG. 8C, the example arrangement of heat-generating elements 802c includes no downstream heat-generating elements and instead positions the heat-generating elements adjacent to each other in a linear fashion across the heat sink 800c. The arrangement shown in FIG. 8C results in each heat-generating element 802c receiving “clean” air moving through the air-moving device an no heat-generating element receiving “dirty” air warmed by an upstream heat-generating element.

FIG. 8D shows a heat sink 800d with another example arrangement of heat-generating elements 802d. The heat-generating elements 802d and 802e are arranged, in this example, in an n×m offset arrangement with n=2 and m=3 where n indicates the quantity of rows of heat-generating elements and m indicates the quantity of heat-generating elements per row. Other values for n and m again are possible and will be appreciated with the benefit of this disclosure. As seen in FIG. 8D, the example arrangement of heat-generating elements 802d includes no heat-generating elements that receive “dirty” air warmed by an upstream heat-generating element. Although the heat-generating elements 802e are located downstream of the heat-generating elements 802d, the heat generating elements 802d and 802e are offset from each other such that each receives “clean” air moving through the air-moving device. The offset arrangement of heat-generating elements also more evenly distributes the generated heat across the heat sink 800d.

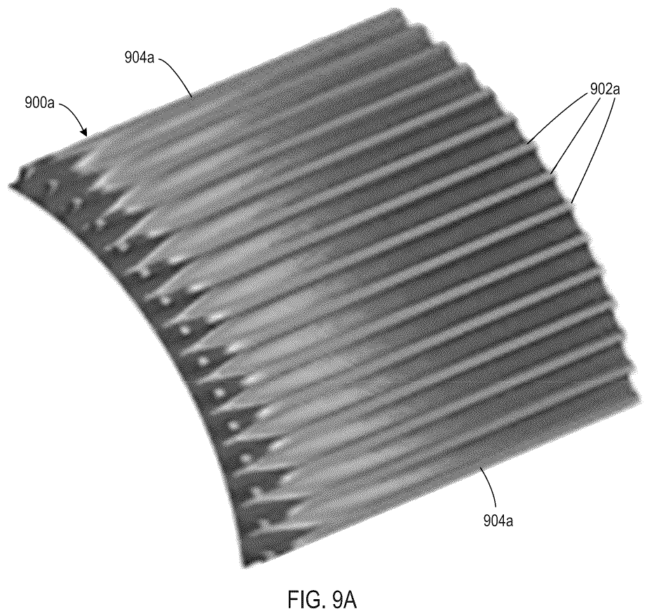

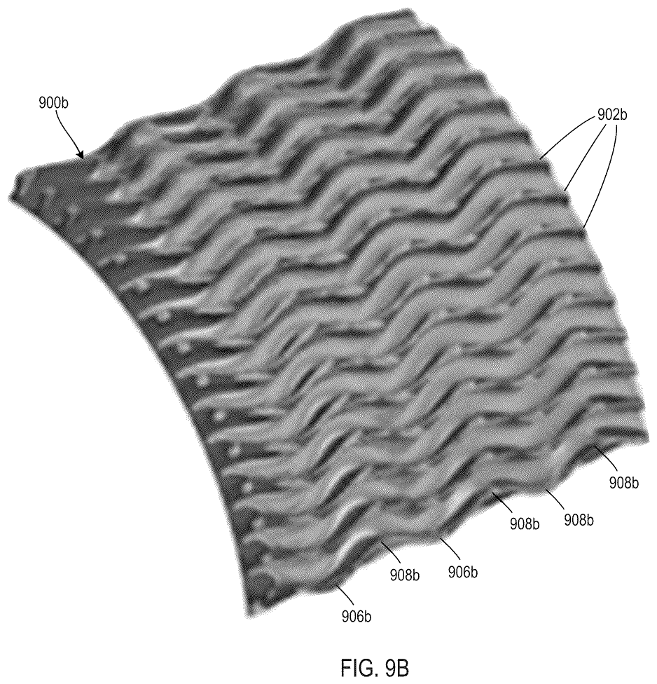

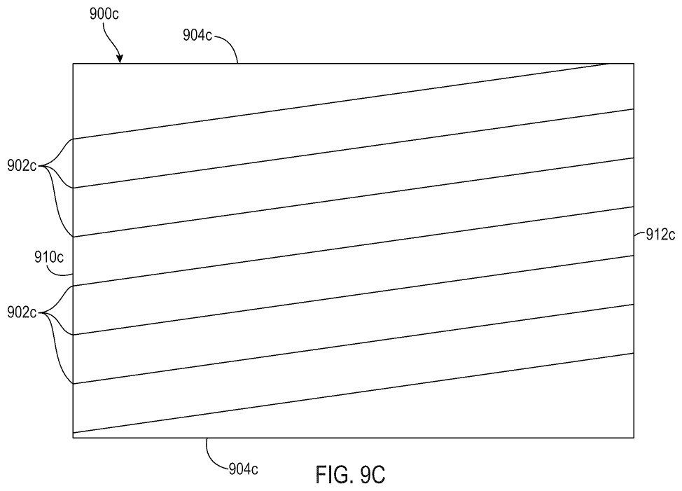

FIGS. 9A-C depict example configurations of heat-dissipating structures of a heat sink. The heat sink 900a shown in FIG. 9A includes straight, axially extending heat-dissipating structures 902a (e.g., fins) that are substantially parallel with the lateral sides 904a of the heat sink. Straight heat-dissipating structures may be employed where the heat sink is located aftward of the aerodynamic rotor and the aerodynamic stator. The aerodynamic stator may be configured to deswirl the air propelled by the aerodynamic rotor as it moves through the air-moving device. The channels defined by the straight, axially-extending heat-dissipating structures thus align with the deswirled air propelled through the air-moving device. The heat sink 900b shown in FIG. 9B includes wavy, axially-extending heat-dissipating structures 902b (e.g., fins) that undulate and define lateral (side-to-side) peaks 906b and lateral valleys 908b as the heat-dissipating structures extend along the heat sink. Wavy heat-dissipating structures may, in some examples, provide improved heat-dissipating effects as compared to other configurations of heat-dissipating structures (e.g., straight heat-dissipating structures). The peaks and valleys of wavy heat-dissipating structures may have a generally curved shape (e.g., sinusoidal) as shown by way of example in FIG. 9B. More generally, heat-dissipating structures may be straight or non-straight with non-straight heat-dissipating structures conforming to various waveforms (e.g., sinusoidal waveforms, square waveforms, triangle waveforms, sawtooth waveforms, etc.), which may be periodic or aperiodic. In some examples, heat-dissipating structures may combine different configurations. For example, heat-dissipating structures may include a straight portion and a non-straight portion. In another example, heat-dissipating structures may include multiple non-straight portions of different types (e.g., a first non-straight portion conforming to a first type of waveform and a second non-straight portion conforming to a second type of waveform; a first non-straight portion conforming to a first type of waveform, a second non-straight portion conforming to a second type of waveform, and a third non-straight portion conforming to a second type of waveform; a first non-straight portion conforming to a periodic waveform and a second non-straight portion conforming to an aperiodic waveform). The heat sink 900c shown in plan view in FIG. 9C includes heat-dissipating structures 902c (e.g., fins) that are skewed relative to a forward end 910 and an aftward end 912 of the heat sink. As seen in FIG. 9C, the heat-dissipating structures 902c are not parallel with the lateral sides 904c of the heat sink but rather oriented at an oblique angle relative to the lateral sides. Skewed heat-dissipating structures may be used, for example, in air-moving devices (e.g., propulsors) that position the control unit (e.g., an ESC) between the aerodynamic rotor and the aerodynamic stator (aftward of the aerodynamic rotor and forward of the aerodynamic stator) where the air propelled by the aerodynamic rotor is not deswirled before reaching the heat sink. Skewed heat-dissipating structures thus may better facilitate heat dissipation when the air that reaches the heat sink is deswirled air.

Air-moving devices as described may include various types of air-moving devices. Examples of air-moving devices include propulsors for aircrafts such as airplanes (e.g., electric airplanes), drones, and the like; hand-operated equipment such as leaf blowers, snow blowers, hair dryers, and the like; various types of fans such as aircraft fans, stove-top fans, bathroom fans, computer fans (e.g., server fans, laptop fans, desktop fans), cooling fans, ventilation fans, heating-ventilation-air conditioning (HVAC) fans, blower fans (e.g., carpet dryers, race track dryers, car wash dryers); air purifiers, humidifiers, ice making devices, snow-making devices, and other types of air-moving devices that move air via operation of a motor and/or control unit.

Alternative implementations of a control unit assembly are contemplated. For example, a heat sink may omit heat-dissipating structures and instead rely on the stator vanes of the stator to dissipate the heat transferred away from the heat-generating elements of the control unit. In this alternative example, a heat sink of a control unit assembly may have a smooth bottom surface defining a contour that conforms to a peripheral contour defined by the stator vanes (e.g., the circumferential perimeter of the stator). The tips of the stator vanes may be in thermal contact with the smooth bottom surface of the heat sink. Heat transferred away from the heat-generating elements of the control unit and through the smooth bottom surface of the heat sink, in this example, thus may be dissipated via the stator vanes in thermal contact with the smooth bottom surface. In another alternative example, a heat sink may include a bottom surface that defines a contour that conforms to a contour defined by the stator vanes of a stator and includes heat-dissipating structures that define channels having a size and shape sufficient to receive the stator vanes. In this other alternative example, a control unit assembly may be mounted over the stator such that one or more stator vanes are positioned between respective pairs of heat-dissipating structures (e.g., fins) and are in thermal contact with the bottom surface of the heat sink. In this way, heat transferred from the heat-generating elements of the control unit may be dissipated via both the heat-dissipating structures of the heat sink and the stator vanes of the stator. In a further alternative example, one or more heat-generating elements of the control unit (e.g., MOSFETs) may be mounted directly on the stator vanes of the stator and connected to the substrate of the control unit via leads. In this way, the stator vanes may dissipate the heat generated by the heat-generating elements that are in thermal contact with the stator vanes.

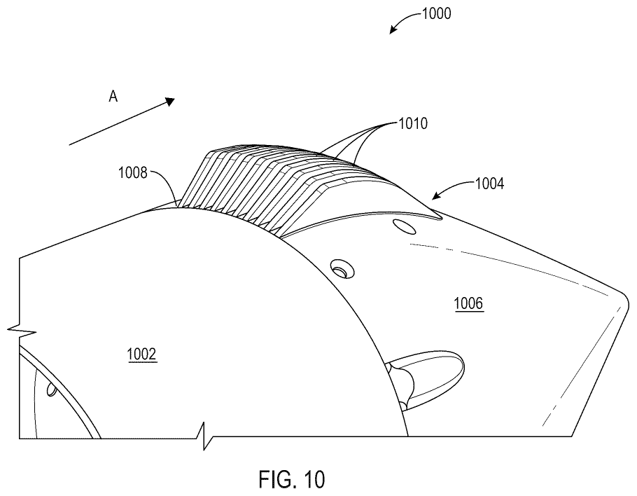

Although various examples described herein are shown with a heat sink extending into the thrust-generating flow path via an opening or protrusion in an outer housing or nacelle of a duct, such as duct 104 of propulsor 100 shown by way of example in FIG. 1, the implementations are not intended to be so limited and are merely examples. In this regard, the same principles apply to heat sinks extending from other structures, such as a center body of a thrust-generating device such as a propulsor. FIG. 10 is a partial side perspective view of an example thrust-generating device, a propulsor 1000 in this example, having a novel heat-dissipating device 1004 that extends from a center body 1002 into the thrust-generating flow path. The thrust-generating device 1000 may be, for example, a propulsor or other device configured to move air, such as being identical or similar to propulsor 100 of FIG. 1. The thrust-generating producing device (e.g., propulsor 1000) may be configured to provide a thrust-generating air flow generally along direction A. The thrust-generating device may include a center body, such as center body 1002 of propulsor 1000, which may be held in place via a plurality of stators and/or other structural elements.

One or more heat sinks, such as heat sink 1004 of propulsor 1000, may be positioned on or partially within various locations of the center body of the thrust-generating device, e.g., center body 1002. For example, the heat sink 1004 is shown on a tail cone or aft portion 1006 of the center body 1002. Other locations may also be utilized. The heat sink 1004 may have a base 1008 or other structure (e.g., as described herein) that is configured to conduct heat away from heat-generating elements which may be located in or on the center body 1002. Heat-dissipating structures, such as fins 1010, may be configured as discussed herein to extend away from the base 1008 and into the thrust-generating flow path. Characteristics, operation, and/or benefits of the heat sink 1004 may be similar or identical to one or more examples described herein, except that such heat sink is associated with a portion of a center body, such as the center body 1002 of the propulsor 1000, as opposed to another surface, such as the duct 104 shown in FIG. 1.

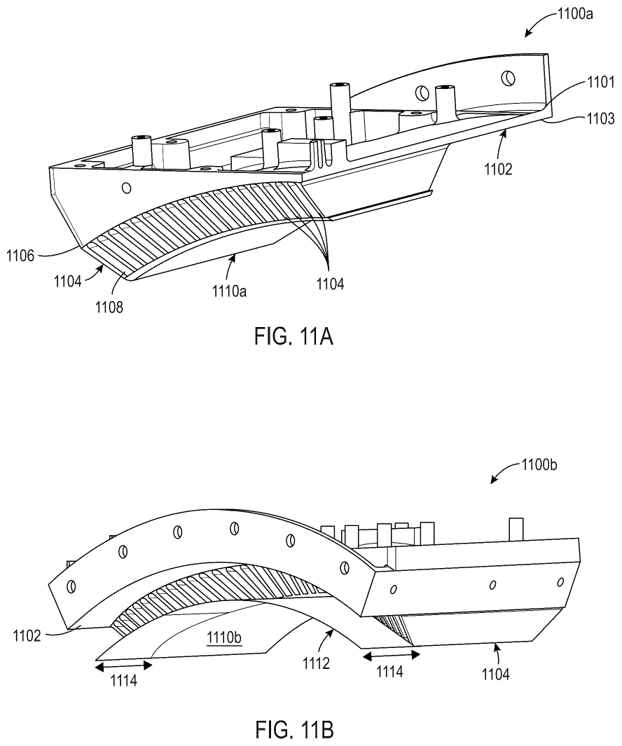

FIGS. 11A and 11B depict perspective views of example shrouded heat sinks according to various aspects described herein. Specifically, FIG. 11A depicts a cross-sectional perspective view of a first example heat sink 1100a having a shroud 1110a according to a first example, and FIG. 11B a perspective view of a second example heat sink 1100b having an extended shroud 1110b. As seen in FIGS. 11A and 11B, the heat sink 1100a and 1100b may have a first side 1101 of a base 1102 which is configured to abut or otherwise be in thermal communication with heat-generating sources. Such contact may be direct, via other conductive surfaces or elements, such as thermal paste. The heat sink 1100a further comprises a second opposing side 1103 from which a plurality of heat-dissipating elements (e.g., fins 1104) configured to aid heat transfer may extend from.

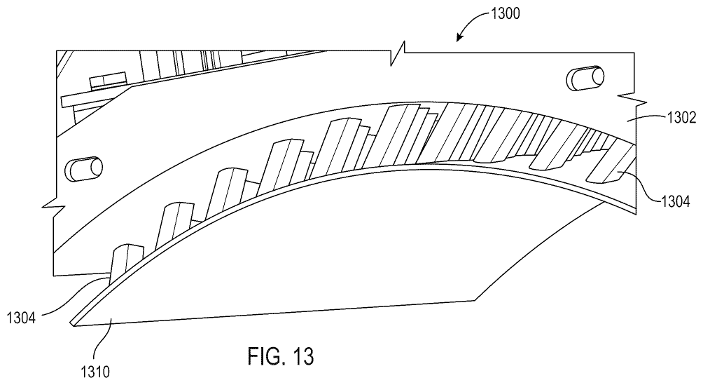

Although the term “fins” is used throughout this disclosure for convenience, those skilled in the art will appreciate that other heat-dissipating structures may be utilized and that fins are used to explain certain embodiments depicted in a variety of the figures herein. In this regard, FIG. 13, discussed below, depicts an example in which a plurality of pins may be used. Other structures, such as baffles, may be used. Heat-dissipating structures (e.g., fins 1104) are shown as generally extending from a first end 1106 proximate to and in thermally conductive contact with one or more heat-generating elements, such as but not limited to those disclosed herein, and extend into the flow path to terminate in a second end 1108. As shown in FIG. 11A, the heat sink 1100a, in this example, is depicted with a shroud 1110a that is generally conformal with a terminal portion of the second ends (e.g., end 1108) of at least a portion of the plurality of fins 1104. Thus, while the shroud 1110a, in this example, is shown to be in thermal contact with the entire length of every heat-dissipating structure (e.g. fins 1104), there is no such requirement in other examples where a shroud may be in thermal contact with less than the entire length of one or more heat dissipating structures, such as fins, baffles, and/or pins, among others.

In some examples, a shroud, such as the shrouds 1110a and 1110b, may be less intrusive to the free stream flow generated by the propulsor (not shown in FIGS. 11A and 11B, but example propulsors are shown throughout this disclosure including propulsor 100 having thrusted air travel through duct 104) as compared to freestanding (e.g., an unshrouded) heat transfer devices of the same type and/or size. The characteristics of the resultant shrouded heat sinks 1100a and 1100b that are best suited to direct flow past the fins 1104 for greater heat transfer efficiency may be based on a balance of, amongst other things, desired heat exchange and aerodynamic performance.

The shroud 1110a and 1110b may comprise or consist of the same materials as one or more of the heat-dissipating structures (e.g., fins 1104). In other examples, a shroud, such as the shrouds 1110a and 1110b, or a portion thereof may comprise or consist of different materials, or different ratios of materials than the heat-dissipating structures, such as fins 1104. In some examples, a structure that comprises the plurality of heat-dissipating structures (e.g., fins 1104) and the shroud (e.g., shroud 1110a and 1110b) is a unitary structure. In other examples, the plurality of heat-dissipating structures (e.g., fins 1104) and the shroud (e.g., shroud 1110a and 1110b) may be separate structures (i.e., non-unitary structures). In this regard, aspects of the present disclosures may apply to both single-part heat sinks and multi-part heatsinks. Examples of single-part heat sinks include homogenous single-part heat sinks, monolithic single-part heat sinks, and contiguous single-part heat sinks. A homogenous single-part heat sink may, for example, comprise a general uniform material(s) or composition(s) throughout and include the shroud, the heat-dissipating structures, and at least a portion of the base. A homogenous heat sink may, for example, be formed entirely of a singular volume or a single layer of a single material, multiple layers of the same material, etc. A monolithic single-part heat sink as described herein, for example, may be integrally formed of a single continuous component comprising a material or a group of materials without seams or joints. For example, in one example, a monolithic heat sink may be created by employing computer numerical control (CNC) manufacturing methods on a composite, alloy, or material. A monolithic single-part heat sink thus may be homogenous (if integrally formed of the same continuous material) or non-homogenous (if integrally formed of a group of materials). A monolithic single-part heat sink may include, for example, layers of materials (e.g. the same material or different materials) deposited directly on an adjacent layer (e.g., via overmolding and/or additive manufacturing). A contiguous single-part heat sink as described herein may include, for example, at least one layer (e.g., an inner core layer, an outer overmold layer) that transitions without interruption from one component of the single-part heat sink (e.g., a fin or other heat-dissipating structure) to another component of the single-part heatsink (e.g., the base, the shroud). A contiguous single-part heatsink thus may homogenous (if integrally formed of the same material), non-homogenous (if integrally formed of different materials, for example, contiguous layers of different materials), monolithic (if integrally formed of one or more layers), or nonmonolithic (if constructed of separately constructed components).

In some examples, a shroud, such as shrouds 1110a and 1110b, is not integrally formed with at least a portion of the heat-dissipation structures, such as one or more of fins, pins, or baffles. In one example, the shrouds 1110a and 1110b may be connected or configured to be in thermal contact with at least a portion of the plurality of fins 1104 only upon placing a device (which may include heat-generating elements as well) with the fins 1104 into a duct, such as any airpath duct disclosed herein. For example, a structure that is shaped to be as part of or within part of a duct may already have a component that serves as a shroud (e.g., shroud 1110a and 1110b) upon placement of the heat dissipating elements (e.g., fins 1104) into an intended configuration. Such contact may be facilitated by a thermal paste, structure, glue, which may be reusable or single use to assist or improve with thermal conductivity between the heat-dissipating structures (e.g., fins 1104) and shroud (e.g., shroud 1110a or shroud 1110b). In this regard, certain examples are envisioned in which a shroud is generally formed or otherwise positioned within a duct. Based on intended usage and/or other factors, various combinations and/or orientations of heat-dissipating structures may be swappable within the duct to make contact with the shroud such that different thermal profiles are provided.

Aspects further relate to extended shrouds and using extended shrouds in novel configurations. FIG. 11B shows a perspective view of a heat sink 1100b having an extended shroud 1110b according a second example. For ease of understanding, FIG. 11B depicts a heat sink 1100b similar to the heat sink 1100a of FIG. 11B, however, the shroud 1110b is shown as being or comprising an extended shroud 1112. Extended shroud 1112 in this example extends forward of the heat-dissipating structures (e.g., fins 1104) by a distance (e.g., distance 1114). The distance may depend on the particular implementation but is designed to allow airflow to flow through the fins 1104 or other heat-dissipating structures. The distance 1114 may be variable, such that the distance from a terminal end 1116 (e.g., front face, leading surface, forward edge, etc.) of the extended shroud 1112 to fins 1104 (e.g., a front face, leading surface, forward edge of the fins) may vary at different locations.

As shown in FIG. 11B, the profile of extended shroud 1112 may be congruent with the respective surface of base 1102 (e.g., side 1103 of the base 1102 in FIG. 11A). In some certain examples, only a portion of profile of the extended shroud 1112 may be congruent with the respective proximate surface of the base 1102. In other examples, the profile of the extended shroud 1112 is not congruent with the respective surface of the base 1102. As further shown in FIG. 11B, at least a portion of the profile of the extended shroud 1112, in this example, may be similar or identical to the profile of the remaining portion of the shroud 1110b. In other examples, the extended shroud 1112 may have a profile that is different than the shroud 1110b.

Aspects of this disclosure relate to providing cooling via thrusted air in the air flow path of a thrust-generating device in a manner that provides less blockage to the thrusted air. Thrusted air may also be referred to as a thrusted airflow. A thrust-generating device, such as a propulsor, may be described therefore as generating a flow of thrusted air, whether the thrusted air be “pushed” or “pulled.” The flow of thrusted air may be described as traveling along a thrust-generating air flow path (or simply thrust-generating flow path). In some thrust-generating devices, at least a portion of the air from the thrust-generating air flow path may be diverted as it travels through the thrust-generating device. The flow of air diverted from the thrust-generating air flow path may be referred to, for convenience, as a diverted air flow path (or simply a diverted flow path). In some examples, the diverted air flow path may be diverted into one or more recesses, cavities, and/or sub-housings of the thrust-generating device. For example, air diverted into a recess of a thrust-generating device may be referred to, for convenience, as recessed air flow path (or simply recessed flow path). The flow of air that is not diverted from the thrust-generating flow path may be referred to, again for convenience, as the primary air flow path (or simply primary flow path). As one example, a propulsor may have a primary flow path that utilizes traditional exhaust flows and routes. In some implementations, some or all of the air of a diverted flow path (e.g., air diverted into a recess, cavity, and/or sub-housing) may rejoin the primary flow path as the thrusted air moves through the thrust-generating device. In other implementations, none of the air of a diverted flow path may rejoin the primary flow path as the thrusted air moves through the thrust-generating device. It will be appreciated that, regardless of whether the thrusted air moves through the thrust-generating device via a primary flow path or a diverted flow path for cooling as described herein, that, in some examples, substantially all (within tolerance limits) of the air diverted for cooling is discharged in a manner to allow it to be utilized for thrust.

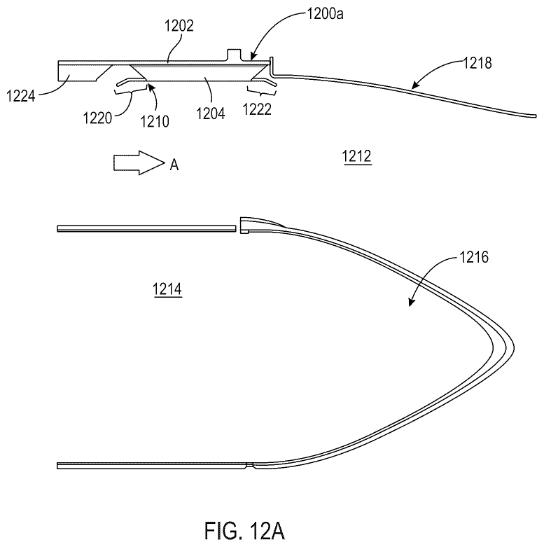

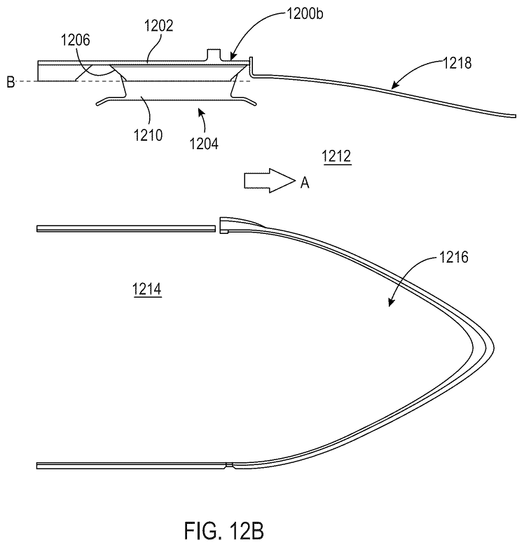

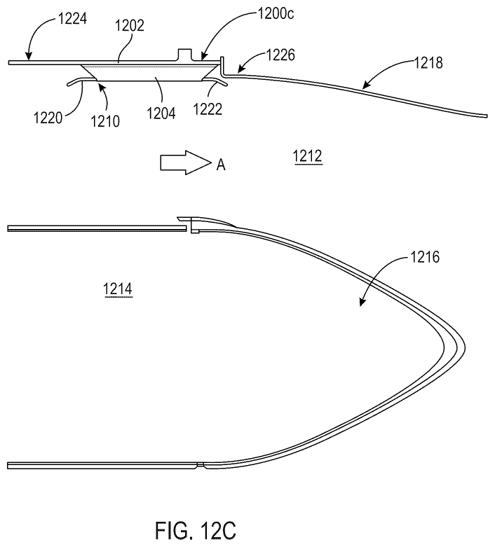

FIGS. 12A-C depict cross-sectional side views of example recessed configurations according to aspects of this disclosure. As shown in FIG. 12, the heat sink 1200a comprises a base 1202 which is configured to abut or otherwise be in thermal communication with heat-generating elements. The heat sink 1200a may be similar or identical to the heat sink 1100a or 1100b of FIGS. 11A and 11B. The heat sink 1200a further comprises a plurality of heat-dissipating structures, fins 1204 in this example configured to aid heat transfer. The fins 1204, in this example, generally extend from away from the base 1202.

In some configurations, a shroud (e.g., shroud 1210) may provide a recessed heat sink (e.g., heat sink 1200a) having less flow path blockage area, to direct flow from the region nearest the duct having the thrust-generating air flow (e.g., duct 1212) and into the heat sink, such as heat sink 1200a. FIGS. 12A, 12B and 12C show examples in which at least a portion of the heat-dissipating structures are recessed with respect to the natural boundaries of the primary flow path of the thrust-generating airflow.

Looking first to FIG. 12A, the duct 1212 is shown in which the thrust-generating airflow is travelling along the direction designated by arrow A and may be positioned between a center body (e.g., center body 1214 having a tail cone 1216) and an outer wall (or nacelle) 1218. For example, the shroud 1210 may comprise an extended shroud 1220 which may include an angled forward section or otherwise be shaped to redirect air towards the heat-dissipating structures (e.g. fins 1204). The forward-facing profile of extended shroud 1220 may serve as a scoop or other mechanism to redirect a portion of the thrust-generating airflow up and into a recess within the housing of the duct 1212. The shroud 1210, in this example, may have an aft extended shroud, such as extended shroud 1222, which may be present in addition to or in lieu of a forward extended shroud, such as extended shroud 1220. The extended shroud 1222, in this example, may be utilized to guide any air flowing through the heat-dissipating structures (e.g., fins 1204) to return to the primary flow path of the thrust-generating airflow.

As seen in FIGS. 12A-12C, at least a portion of the heat-dissipating structures 1204 may be recessed with respect to the general flow of the thrust-generating airflow in such examples. FIG. 12A shows an example in which all or substantially all of the heat-dissipating structures (e.g., fins 1204) terminate at or about the boundary of the primary flow path. For example, the walls or boundary areas at locations 1224 (FIGS. 12A and 12C) and 1226 (FIG. 12C) create a recess such that the heat-dissipating structures are located within the recess.

Looking to FIG. 12B, at least a portion of heat-dissipating structures (e.g., fins 1204) of the heat sink 1200b, in this example, may extend from a recess and into the primary flow path. For example, at least a portion of heat-dissipating structures (e.g., fins 1204) extend below imaginary line B which delineates the general outer boundary of the primary flow path in this example. The heat-dissipating structures (e.g., fins 1204) generally are depicted to have a first end 1206 that extends from away from the base 1202 to a second end 1208 wherein at least a portion of the first end 1206 of the fins 1204 is recessed with respect to the primary flow path of the thrust-generating air (e.g., above dashed line B). In one example, the duct 1212 may be shaped to provide a recess for the heat sink 1200b (e.g., forward portion of duct 1212). Nonetheless, at least a portion of the heat-dissipating structures (e.g., fins 1204) may extend into the primary flow path and terminate in a second end 1208 in some examples. All or some (e.g., a majority) of heat-dissipating structures (e.g., fins 1204) may extend into the thrust-generating flow path. In some examples, only a portion of the total quantity of second ends 1208 extend into the primary flow path of the thrust-generating airflow. In other examples, none of the heat-dissipating structures (e.g., fins 1204) extend into the primary flow path. Examples will be provided below. In some examples, a shroud (e.g., shroud 1210) may provide a recessed heat sink (e.g., heat sink 1200b) having less flow path blockage area to direct flow from the region nearest the duct 1212 (e.g., the center body 1214) and into the heat sink. In some examples, the shroud 1210 may take on the general location of the outer boundary of the primary flow path for the thrust-generating air.

In other examples, the heat-dissipating structures may be used at a transition point or otherwise aligned with one side of the outer wall (or nacelle) 1218 of the duct 1212. As one example, FIG. 12C shows an implementation of a heat sink 1200c in which the diameter of the duct 1212 is wider at location 1224 than at location 1226. Thus, in this example, the heat sink 1200c is located in an area that essentially serves as a transition between a larger radius and a smaller radius. In some examples, the heat sink can be retrofitted onto existing structures, and yet in other embodiments the duct configuration is formed to accommodate one or more heat sinks.

Although FIGS. 12A-12C depict examples in which a heat sink (e.g., heat sinks 1200a, 1200b, and 1200c) is proximate or associated with the outer perimeter of a duct, those skilled in the art with the benefit of this disclosure, including but not limited to FIG. 10, will appreciate that such teachings carry over to other surfaces, such as, for example, located on a center body of a thrust-generating device or thrust-generating system such as a propulsor or propulsion system. As one non-limiting example, at least a portion of the heat dissipating structures (e.g., fins 1010) of the heat sink 1004 shown in FIG. 10 can also be partially or wholly recessed with the center body 1002 of the propulsor 1000. In one example, a shroud, such as shroud 1210 (FIGS. 12A-12C), can be used to direct air from the primary flow path over or around heat-dissipating elements (e.g., fins 1010). In some examples, a shroud, such as shroud 1228 shown in FIG. 12C (alone or with other structures) may direct air within the primary flow path (such as travelling along arrow A) into an interior portion of a center body 1214 which may be returned to the primary air path downstream.

FIG. 13 depicts a perspective view of an example heat sink 1300 having a plurality of pins 1304 in accordance with various aspects disclosed herein. As seen in FIG. 13, the heat sink 1300, in this example, comprises a base 1302 from which a plurality of heat-dissipating structures (e.g., pins 1304) configured to aid heat transfer may extend from. The pins 1304, in this example, may extend away from the base 1302 and may terminate in a shroud such as shroud 1310. Thus, reference to fins, pins, or other heat-dissipating structures in the description of various examples are provided for ease of understanding and conveyance of various aspects disclosed herein and should not be limited unless otherwise stated. Additionally, although the fins 1104 of FIGS. 11A-11B and the pins 1304 of FIG. 13 are each depicted as relatively linear and generally parallel with respect to a neighboring fin, those skilled in the art with the benefit of this disclosure will appreciate that other configurations, orientations, dimensions, etc. may be implemented for example heat sinks including the example heat sink 1300 depicted in FIG. 13, including but not limited to the configurations disclosed in each of the proceeding figures. As discussed above in relation to the heat-dissipating structures (e.g., fins, pins, baffles, etc.), the quantity, density, shape, thickness, and/or other characteristics may be varied in different implementations. For example, certain areas known to have higher heat dissipation may be provided with heat-dissipating structures (e.g., fins, pins, baffles, etc.) having different characteristics than surrounding heat-dissipating structures. It will also be appreciated that, in some examples, a heat sink may combine different types of heat-dissipating structures such that the heat sink provides multiple (e.g., two or more) different types of heat-dissipating structures (e.g., a heat sink with both fins and pins; a heat sink with fins, pins, and baffles; etc.) Colocation of heat sources to fin, pin, and/or baffle density regions may be utilized for optimal conduction or local surface area increase for local convection performance. For example, a length of heat-dissipating structures and/or spacing between them may be based on (influenced by) at least the desired or expected heat to be transferred at around that location. Characteristics of the of shroud and/or heat-dissipating structures pins may be based, at least in part, according to one or more of the following: relative Reynolds number, flow geometry and local flow conditions (e.g., speed, swirl, temperature gradient), and/or or other more aerodynamic shapes to aid the designer in the tradeoff between HTC (heat transfer coefficient) and pressure drop.

The articles “a” and “an” are used herein to refer to one or to more than one (i.e., to at least one) of the grammatical object of the article. By way of example, “an element” means one element or more than one element. Furthermore, “about” as used herein when referring to a measurable value such as an amount, a temporal duration, and the like, is meant to encompass variations of ±20%, ±10%, ±5%, ±1%, and ±0.1% from the specified value, as such variations are appropriate according to the understanding of one of ordinary skill in the art. Throughout this disclosure, various aspects are presented in as numerical range. It should be understood that any description in describing a range is provided for convenience and brevity and should not be construed as an inflexible limitation. Where appropriate according to the understanding of one or ordinary skill in the art, the description of a range should be considered to have specifically disclosed all the possible subranges as well as individual numerical values within that range with an appropriate quantity of significant digits according to the understanding of one or ordinary skill in the art. This applies regardless of the breadth of the range.

While aspects of the present disclosure have been described in terms of preferred examples, and it will be understood that the disclosure is not limited thereto since modifications may be made to those skilled in the art, particularly in light of the foregoing teachings. For example, although various examples are described herein, features and/or steps of those examples may be combined, divided, omitted, rearranged, revised, and/or augmented in any desired manner. Various alterations, modifications, and improvements will be appreciated by those skilled in the art and are intended to be part of this description, even if not expressly stated herein, and are intended to be within the spirit and scope of the disclosures herein. The disclosures herein, therefore, are by way of example only, and are not limiting.

What is claimed is:

1. An air-moving device comprising:
a duct;
a fan configured to move air through the duct;
a control unit configured to control operation of the fan and comprising one or more heat-generating elements; and
a heat sink comprising:
a first surface in direct thermal contact with the one or more heat-generating elements;
a second surface opposite the first surface and defining a contour that conforms to a contour of the duct; and
one or more heat-dissipation structures radially extending away from the second surface into an interior of the duct and configured to dissipate, via the air moved through the duct by the fan, heat transferred away from the one or more heat-generating elements and through the first surface and the second surface of the heat sink.

2. The air-moving device of claim 1, wherein the one or more heat-dissipation structures comprise at least one fin axially extending along the second surface.

3. The air-moving device of claim 1, wherein the one or more heat-dissipation structures comprise a plurality of fins axially extending along the second surface and defining at least one channel axially extending along the second surface.

4. The air-moving device of claim 3, wherein the plurality of fins have different axial lengths.

5. The air-moving device of claim 3, wherein the plurality of fins collectively define a curved fin edge that laterally extends between a first side of the second surface and second side of the second surface.

6. The air-moving device of claim 1, wherein the second surface defines an arcuate contour that conforms to an arcuate contour of the duct.

7. The air-moving device of claim 1, further comprising an aerodynamic stator positioned downstream of the fan, wherein the heat sink is positioned downstream of the stator.

8. The air-moving device of claim 1, further comprising an aerodynamic stator, wherein the one or more heat-dissipation structures are in direct thermal contact with the stator.

9. The air-moving device of claim 1, wherein the one or more heat-dissipation structures extend through cutout defined by an edge of the duct.

10. The air-moving device of claim 1, wherein the air-moving device is an aircraft propulsor.

11. A control unit assembly for an air-moving device comprising:
a control unit configured to control operation of a fan of an air-moving device and comprising one or more heat-generating elements; and
a heat sink mounted to the control unit and comprising:
a first surface in direct thermal contact with the one or more heat-generating elements;
a second surface opposite the first surface and defining a contour that conforms to a contour of a duct of the air-moving device; and
one or more heat-dissipation structures radially extending away from the second surface and configured to dissipate, via air moved through the duct by a fan of the air-moving device, heat transferred away from the one or more heat-generating elements and through the first surface and the second surface of the heat sink.

12. The control unit assembly of claim 11, wherein the one or more heat-dissipation structures comprise a plurality of fins axially extending along the second surface and defining a plurality of channels axially extending along the second surface.

13. The control unit assembly of claim 12, wherein the plurality of fins have different axial lengths.

14. The control unit assembly of claim 11, wherein the control unit comprises a substrate mounted to the first surface of the heat sink, and wherein the one or more heat-generating elements are positioned between the first surface of the heat sink and the substrate.

15. The control unit assembly of claim 11, wherein:
the control unit comprises a substrate; and
the first surface of the heat sink comprises:
a first mounting surface supporting the substrate of the control unit; and
a second mounting surface orientated at an oblique angle relative to the first mounting surface and in direct thermal contact with at least one heat-generating element of the one or more heat-generating elements.

16. The control unit assembly of claim 11, wherein the control unit comprises an electronic speed controller (ESC), and wherein the one or more heat-generating elements comprise at least one metal-oxide-semiconductor field-effect transistor (MOSFET).

17. The control unit assembly of claim 11, wherein the control unit comprises a power source, and wherein the one or more heat-generating elements comprise a plurality of MOSFETs positioned on the first surface of the heat sink substantially equidistant from the power source.

18. The control unit assembly of claim 11, wherein the one or more heat-generating elements comprise a plurality of heat-generating elements arranged such that no heat-generating element is positioned on the first surface of the heat sink downstream of another heat-generating element.

19. The control unit assembly of claim 11, wherein the one or more heat-generating elements are mounted to the first surface of the heat sink via thermal paste.

20. The control unit assembly of claim 11, wherein the control unit is configured to control operation of a propulsor motor.

21. A heat sink for an air-moving device comprising:
a first surface configured to support a substrate of a control unit of an air-moving device and one or more heat-generating elements of the control unit;
a second surface opposite the first surface and defining a contour that conforms to a contour of a duct of the air-moving device; and
one or more heat-dissipation structures radially extending away from the second surface such that, based on the heat sink being mounted to the duct of the air-moving device, the one or more heat-dissipation structures radially extend into an interior of the duct of the air-moving device.

22. The heat sink of claim 21, wherein the one or more heat-dissipating structures comprise a plurality of fins axially extending along the second surface and defining a plurality of channels axially extending along the second surface.

23. The heat sink of claim 22, wherein the plurality of fins have different axial lengths.

24. The heat sink of claim 21, wherein the heat sink has a monolithic construction such that the one or more heat-dissipation structures are contiguous with the second surface.

25. The heat sink of claim 21, further comprising one or more mounting posts extending away from the first surface, wherein the one or more mounting posts are configured to support the substrate of the control unit and are configured to transfer heat generated by one or more heat-generating elements supported on the substrate of the control unit toward the one or more heat-dissipation structures.

26. The heat sink of claim 21, wherein the heat sink is constructed of aluminum.
